(19) United States
(12) Patent Application Publication
(10) Pub. No.: US 2025/0104994 A1
(43) Pub. Date: Mar. 27, 2025

(54) MASS SPECTROMETER AND CONTROL METHOD THEREOF

(71) Applicant: HITACHI HIGH-TECH CORPORATION, Tokyo (JP)

(72) Inventors: Kana NAKAMURA, Tokyo (JP); Tsukasa SHishika, Tokyo (JP); Masaki YOSHIE, Tokyo (JP)

(73) Assignee: HITACHI HIGH-TECH CORPORATION, Tokyo (JP)

(21) Appl. No.: 18/730,986

(22) PCT Filed: Jan. 26, 2022
(86) PCT No.: PCT/JP2022/002948

§ 371 Date: Jul. 22, 2024

(51) Int. Cl. H01J 49/42

(52) U.S. Cl. CPC H01J 49/429; H01J 49/421

(57) ABSTRACT

To provide a mass spectrometer capable of shortening the time required to obtain the mass spectrum over the wide range of the mass-to-charge ratios. A mass spectrometer includes an ionizing unit that generates ions from a sample, a mass filter that separates the ions according to a mass-to-charge ratio, and a detecting unit that detects the ions separated by the mass filter. The mass spectrometer further includes an ion guide that transports the ions to the mass filter, and a control unit that generates a mass spectrum and a mass chromatogram using detection signals obtained by performing a sweep control and a step control, the sweep control gradually increases a high frequency voltage to be applied to the ion guide, and the step control constantly keeps the high frequency voltage.

### TECHNICAL FIELD

The invention relates to a mass spectrometer provided with an ion guide portion and particularly to a control for a voltage to be applied to the ion guide portion.

### BACKGROUND ART

The mass spectrometer is a device for analyzing a sample using a mass spectrum obtained by separating and detecting ions generated from the sample according to a mass-to-charge ratio m/z that is a ratio of mass m and charge z. Many mass spectrometers are provided with ion guides that utilize the convergence function of ion by a high frequency electric field to efficiently transport the generated ions to a mass filter for separating the ions according to the mass-to-charge ratio.

Since the ions are transported while oscillating by the high frequency electric field of the ion guide, the range of the mass-to-charge of the ions allowed to pass through the ion guide depends on the magnitude of the high frequency voltage to be applied to the ion guide. Therefore, to obtain a mass spectrum over a wide range of the mass-to-charge ratios, there is used a method of performing several times of measurements while varying the magnitude of the high frequency voltage and integrating the mass spectra corresponding to the different mass-to-charge ratio ranges obtained from the respective measurements. However, when the mass-to-charge ratio range gets wider, the peak intensity relatively decreases in a region of a low mass-to-charge ratio, compared with the case of a narrower mass-to-charge ratio range.

Patent Literature 1 discloses a mass spectrometer that reduces the decrease of the peak intensity in the low mass-to-charge ratio region. Specifically, it is disclosed that even when the mass-to-charge ratio ranges are different, a high frequency voltage to be applied to the ion guide is set so that the ratio of the measurements at a high frequency voltage where the transmission efficiency of the ions is relatively high, may be even in the low mass-to-charge ratio region.

### CITATION LIST

### Patent Literature

Patent Literature 1: Japanese Patent No. 6923078

### SUMMARY OF INVENTION

### Technical Problem

Patent Literature 1, however, performs a plurality of measurements while varying the magnitude of the high-frequency voltage to be applied to the ion guide, which requires a long time to obtain a mass spectrum over a wide range of the mass-to-charge ratios.

Therefore, it is an object of the present invention to provide a mass spectrometer and the control method capable of shortening the time required to obtain the mass spectrum over the wide range of the mass-to-charge ratios.

### Solution to Problem

To achieve the above object, the invention is a mass spectrometer having an ionizing unit that generates ions from a sample, a mass filter that separates the ions according to a mass-to-charge ratio, and a detecting unit that detects the ions separated by the mass filter, characterized by further including an ion guide that transports the ions to the mass filter and a control unit that generates a mass spectrum and a mass chromatogram using detection signals obtained by performing a sweep control for gradually increasing a high frequency voltage to be applied to the ion guide and a step control for constantly keeping the high frequency voltage.

The invention is a control method of a mass spectrometer having an ionizing unit that generates ions from a sample, a mass filter that separates the ions according to a mass-to-charge ratio, and a detecting unit that detects the intensity of every separated ion, characterized in that a mass spectrum and a mass chromatogram are generated using detection signals obtained by performing a sweep control for gradually increasing a high frequency voltage to be applied to the ion guide that transports the ions to the mass filter and a step control for constantly keeping the high frequency voltage.

### Advantageous Effects of Invention

According to the invention, it is possible to provide a mass spectrometer and the control method capable of shortening the time required to obtain the mass spectrum over the wide range of the mass-to-charge ratios.

### BRIEF DESCRIPTION OF DRAWINGS

FIG. 1 shows an example of the whole structure of a mass spectrometer according to a first embodiment.

FIG. 2 shows an example of ion transmittance in an ion guide.

FIG. 3 shows an example of a stable region and an unstable region in a mass filter.

FIG. 4A shows an example of a control pattern of a high frequency voltage applied to the ion guide.

FIG. 4B shows an example of a control pattern of a high frequency voltage applied to the ion guide.

FIG. 5 shows an example of a control pattern of a high frequency voltage applied to the ion guide.

FIG. 6A shows an example of a mass spectrum in a first scanning range 5 to 130.

FIG. 6B shows an example of a mass spectrum in a second scanning range 70 to 530.

FIG. 6C shows an example of a mass spectrum in a third scanning range 470 to 1000.

FIG. 7 shows an example of a mass spectrum in a mass-to-charge ratio range 5 to 1000.

### DESCRIPTION OF EMBODIMENTS

Hereinafter, referring to the attached drawings, a mass spectrometer and the control method according to the invention will be described with a preferred embodiment. The mass spectrometer is a device for analyzing a sample using a mass spectrum obtained by separating and detecting ions generated from the sample according to a mass-to-charge ratio m/z that is a ratio of mass m and charge z.

### First Embodiment

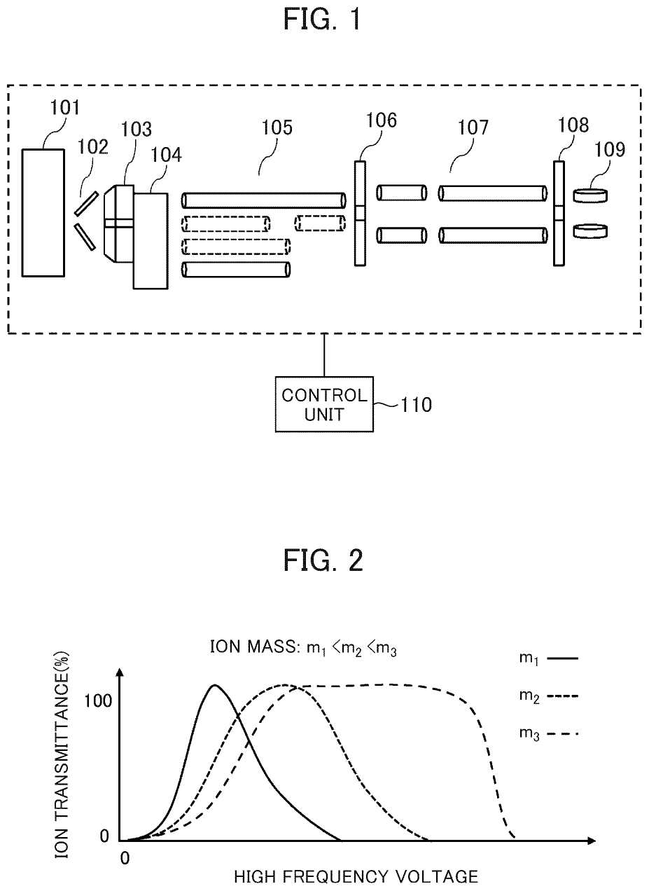

With reference to FIG. 1, an example of the whole structure of the mass spectrometer according to a first embodiment will be described. The mass spectrometer is provided with an ionizing unit 101, a counter plate 102, an off-axis unit 104, an ion guide 105, a mass filter 107, a detector 109, and a control unit 110. Hereinafter, the respective units will be described.

The ionizing unit 101 is a device that generates ions from a sample. For example, a solution containing the sample is poured into a capillary with a high voltage applied there, charged droplets are generated by spraying the solution from the distal end of the capillary, and the charged droplets are heated and vaporized, hence to generate the ions of the sample.

The counter plate 102 has holes through which ions are taken, to form an electric field for capturing the ions. Further, a gas flows in the opposite direction to the ion taking direction to suppress the capture of neutral particles other than the ions. The ions captured in the counter plate 102 are guided to the off-axis unit 104 through a first fine pore 103.

The off-axis unit 104 deflects the ions by the electric field to pass the above downstream, thereby removing the neutral particles other than the ions. The deflected ions by the off-axis unit 104 are guided to the ion guide 105.

The ion guide 105 is a device that transports the ions to the mass filter 107 in the subsequent stage. The ions passing through the ion guide 105 are guided to the mass filter 107 through a second fine pore 106. The ion guide 105 is formed, for example, with even number of four or more lot electrodes arranged in parallel along the ion proceeding direction, and a high frequency voltage of the same intensity and different polarity is applied to the adjacent lot electrodes. The high electric field formed in the ion guide 105 by the application of the high frequency voltage oscillates the ions, and the magnitude of the oscillation of the ions depends on the mass-to-charge ration of the ion and the magnitude of the high frequency voltage. In short, the ion transmittance that is the ratio of the ions passing through the ion guide 105 varies according to the mass-to-charge ratio of the ion and the magnitude of the high frequency voltage.

FIG. 2 shows an example of the ion transmittance varying according to the ion mass and the high frequency voltage. The vertical axis of FIG. 2 is the ion transmittance and the horizontal axis is the high frequency voltage. As shown in FIG. 2, the magnitude of the high frequency voltage that results in a high ion transmittance depends on the ion mass; in the case of a light ion, the ion transmittance is high at a smaller high frequency voltage and in the case of a heavy ion, it is high at a larger high frequency voltage. Here, the relationship shown in FIG. 2 may be previously recorded and read out according to the necessity.

The mass filter 107 is a device that separates the ions according to the mass-to-charge ratio m/z that is the ratio of mass m and charge z. The ions passing through the mass filter 107 are guided to the detector 109 through a third fine pore 108. The mass filter 107 is formed, for example, with four lot electrodes arranged in parallel along the ion proceeding direction, and a high frequency voltage of the same intensity and different polarity and a direct current are applied to the adjacent lot electrodes. The range of the mass-to-charge of the ions passing through the mass filter 107 is restricted to the magnitude of the high frequency voltage and the direct current voltage.

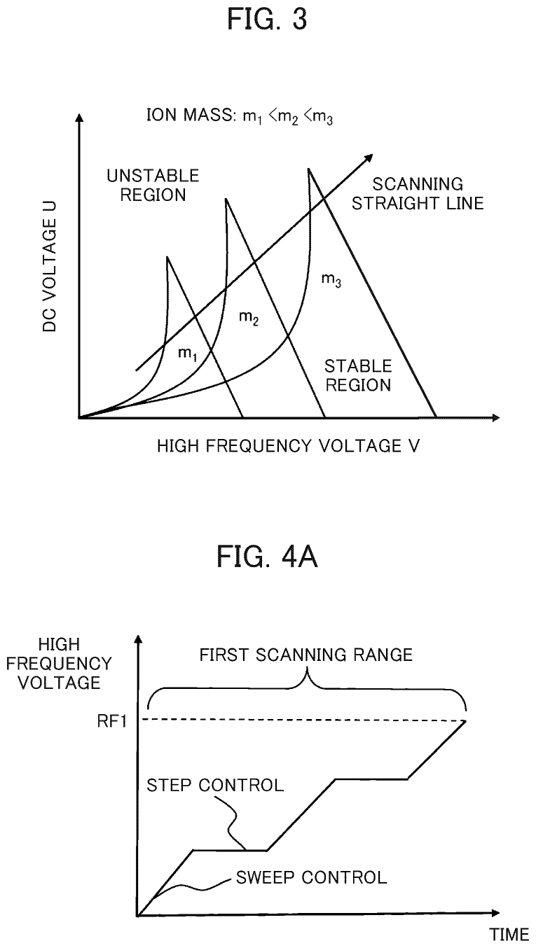

FIG. 3 shows a stable region in which the oscillation of the ions converges and an unstable region in which the above diverges in the mass filter 107, in a coordinate system with the axes of the high frequency voltage V and the direct current voltage U. Since the stable region varies according to the mass of the ions, it is necessary to set the high frequency voltage V and the direct current voltage U according to the mass of the ions to be measured. A mass spectrum can be obtained by constantly keeping the ratio of the high frequency voltage V and the direct current voltage U, in other words, by continuously changing the two voltages along the scanning straight line in the figure.

The detector 109 is a device that detects the ions separated according to the mass-to-charge ratio, including a conversion dynode, a scintillator, a photomultiplier, and the like. The detection signal output by the detector 109 is transmitted to the control unit 110.

The control unit 110 is a device that controls each unit and is formed, for example, by a computer. The control unit 110 generates a mass spectrum in which the ion intensities are plotted for every mass-to-charge ratio and a mass chromatogram in which the ion intensity of a specified mass-to-charge ratio is recorded with time, based on the detection signal transmitted from the detector 109. The generated mass spectrum and mass chromatogram are displayed on a monitor and used for analysis of the sample. Further, the control unit 110 controls the high frequency voltage to be applied to the ion guide 105 so that the mass spectrum in a wide range of the mass-to-charge ratio can be obtained only by one measurement.

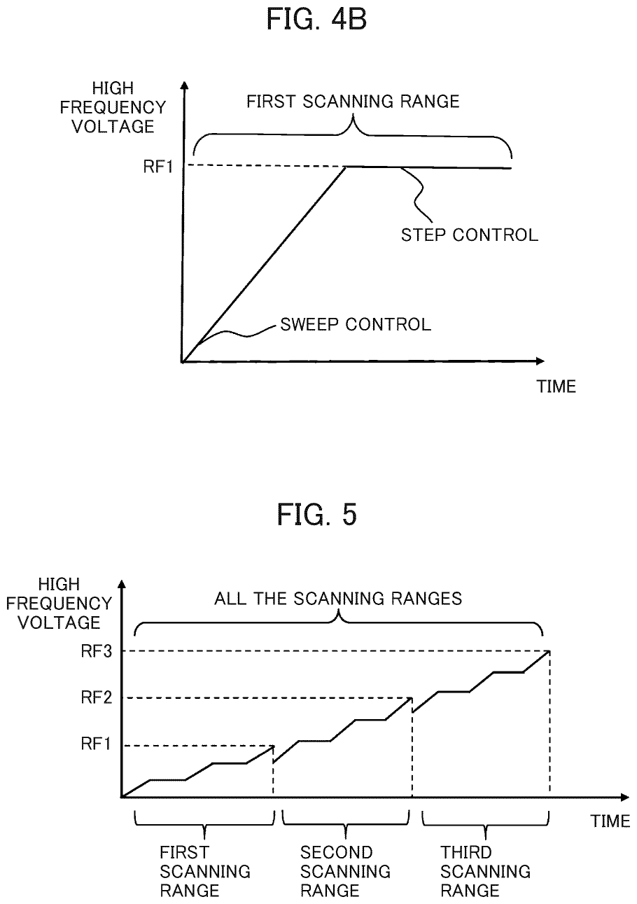

An example of a control pattern of the high frequency voltage to be applied to the ion guide 105 will be described using FIGS. 4A and 4B. The control unit 110 performs a sweep control for gradually increasing the high frequency voltage to be applied to the ion guide 105 and a step control for constantly keeping the high frequency voltage. The number of the times of the sweep control and the step control is not limited but, as shown in FIG. 4A, the sweep control may be performed three times and the step control twice, or as shown in FIG. 4B, each sweep control and step control may be once.

While performing the sweep control and the step control on the ion guide 105, the high frequency voltage V and the direct current voltage U to be applied to the mass filter 107 are controlled to continuously change along the scanning straight line as shown in FIG. 3, hence to generate the mass spectrum. During the sweep control and the step control for the ion guide 105, when the high frequency voltage V and the direct current voltage U of the mass filter 107 are kept constant, only the ions of a specified mass-to-charge ratio are detected, hence to generate the mass chromatogram.

When the sweep control is performed on the ion guide 105, the ions in a wide range of the mass-to-charge ratio can reach the mass filter 107, which allows only one measurement to obtain the mass spectrum, thereby reducing the time required for the measurement.

Further, by performing the step control at a proper timing, the measurement accuracy can be improved. For example, at the timing when the gradually-increasing high frequency voltage by the sweep control reaches the range in which a change of the ion transmittance is small, the sweep control is switched to the step control. By switching to the step control, the ions can be stably transported to the mass filter 107, which improves the measurement accuracy. The range of the high frequency voltage in which the change of the ion transmittance is small may be obtained from the data showing the relationship between the ion transmittance and the high frequency voltage as shown in FIG. 2.

Another example of a control pattern of the high frequency voltage to be applied to the ion guide 105 will be described using FIG. 5. In FIG. 5, the whole scanning range is divided into three scanning ranges, and in each scanning range, the sweep control and the step control are performed arbitrary number of times. For example, when the range of the mass-to-charge ratios 5 to 1000 is measured in the whole scanning range, the above ratios 5 to 100 are measured in the first scanning range, the above ratios 100 to 500 in the second scanning range, and the above ratios 500 to 1000 in the third scanning range. As shown in FIG. 2, since the high frequency voltage showing the high ion transmittance varies according to the ion mass, the high frequency voltage of the ion guide 105 is set preferably according to the mass-to-charge ratio of measurement target. Specifically, in the first scanning range of measuring the range of the mass-to-charge ratios 5 to 100, a comparatively smaller high frequency voltage is set, and in the third scanning range of measuring the range of the mass-to-charge ratios 500 to 1000, a comparatively larger high frequency voltage is set. Here, each scanning range is preferably set larger than the mass-to-charge ratio range of the measurement target.

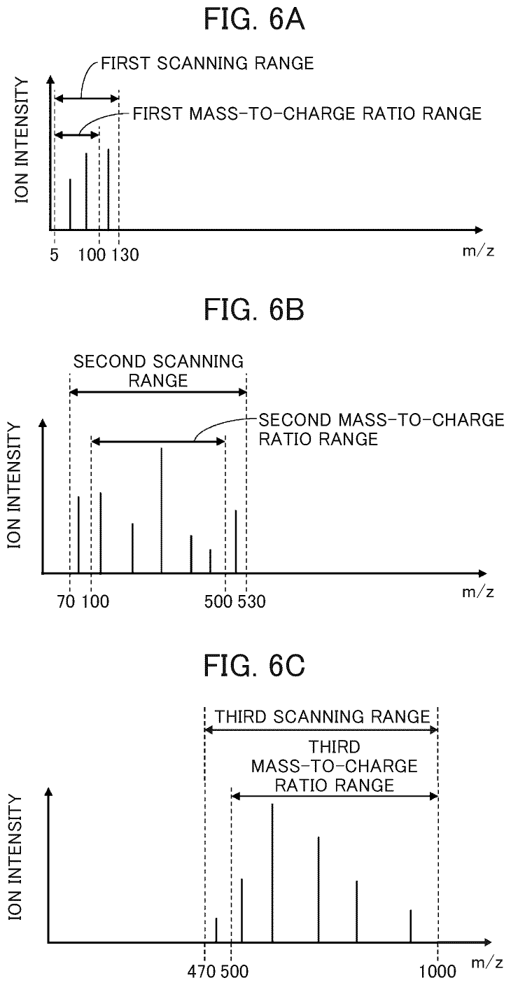

The mass-to-charge ratio range and the scanning range will be described with reference to FIGS. 6A to 6C. FIG. 6A shows the mass spectrum measured when the first scanning range is set at 5 to 130 as for the measurement target mass-to-charge ratio range 5 to 100. In short, the first scanning range is wider than the measurement target mass-to-charge ratio range by 30. Further, FIG. 6B shows the results of the measurement with the second scanning range 70 to 530 set for the mass-to-charge ratio range 100 to 500. In short, the second scanning range is wider than the measurement target mass-to-charge ratio range by 60. Further, FIG. 6C shows the results of the measurement with the third scanning range 470 to 1000 set for the mass-to-charge ratio range 500 to 1000. In short, the third scanning range is wider than the measurement target mass-to-charge ratio range by 30. By setting the scanning range wider than the measurement target mass-to-charge ratio range, it is possible to reduce the detection leakage of the ions.

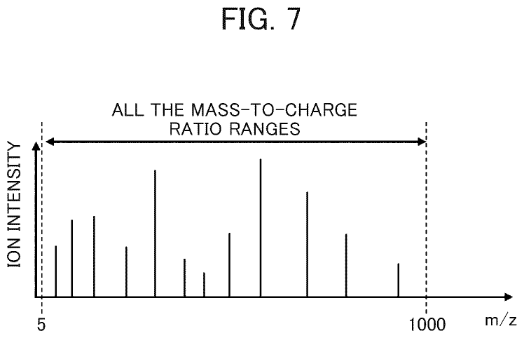

FIG. 7 shows an example of the mass spectrum in the mass-to-charge ratio range 5 to 1000 generated by integrating the measurement results as shown in FIGS. 6A to 6C. In a region where the scanning ranges overlap with each other, the data of the higher ion intensity is adopted.

As set forth hereinabove, by performing the sweep control and the step control on the ion guide 105, it is possible to reduce the time required for obtaining the mass spectrum in a wide range of the mass-to-charge ratios. Further, it is possible to improve the measurement accuracy by switching from the sweep control to the step control at a proper timing.

As mentioned above, the embodiment of the invention has been described. The invention is not restricted to the above embodiment but the components may be modified without departing from the spirit of the invention. Further, a plurality of the components described in the above embodiment may be properly combined. Furthermore, some of the components may be deleted from the whole components described in the above embodiment.

### LIST OF REFERENCE SIGNS

101: ionizing unit, 102: counter plate, 103: first fine pore, 104: off-axis unit, 105: ion guide, 106: second fine pore, 107: mass filter, 108: third fine pore, 109: detector, 110: control unit

1. A mass spectrometer comprising:
an ionizing unit that generates ions from a sample;
a mass filter that separates the ions according to a mass-to-charge ratio; and
a detecting unit that detects the ions separated by the mass filter, wherein,
the mass spectrometer further includes comprising:
an ion guide that transports the ions to the mass filter; and
a control unit that generates a mass spectrum and a mass chromatogram, using detection signals obtained by performing a sweep control and a step control, the sweep control for gradually increasing a high frequency voltage to be applied to the ion guide, and the step control constantly keeping the high frequency voltage, wherein
the control unit switches from the sweep control to the step control, at a timing when the high frequency voltage gradually increased by the sweep control reaches a range in which a change of ion transmittance is small.

2. The mass spectrometer according to claim 1, wherein the control unit switches from the sweep control to the step control, at a timing when the high frequency voltage gradually increased by the sweep control reaches a range in which a change of ion transmittance is small predetermined value or more of the ion transmittance.

3. A control method of a mass spectrometer having an ionizing unit that generates ions from a sample, a mass filter that separates the ions according to a mass-to-charge ratio, and a detecting unit that detects intensity for every separated ion, comprising a step the steps of:
generating a mass spectrum spectrometer and a mass chromatogram using detection signals obtained by performing a sweep control and a step control, the sweep control for gradually increasing a high frequency voltage to be applied to an ion guide that transports the ions to the mass filter, and the step control for constantly keeping the high frequency voltage; and
switching the sweep control to the step control, at a timing when the high frequency voltage gradually increased by the sweep control reaches a range in which a change of ion transmittance is small.

4. The control method according to claim 3, wherein the sweep control is switched from the sweep control to the step control, at a timing when the high frequency voltage gradually increased by the sweep control reaches a range in which a change of ion transmittance is small predetermined value or more of the ion transmittance.
